(19) United States
(12) Patent Application Publication
(10) Pub. No.: US 2026/0049660 A1
(43) Pub. Date: Feb. 19, 2026

(54) CYLINDER HEAD GASKET AND CYLINDER LINER FOR INTERNAL COMBUSTION ENGINE

(71) Applicant: Caterpillar Inc., Peoria, IL (US)

(72) Inventors: Aaron Ness, Battle Ground, IN (US); Alonzo Peter Borchert, West Lafayette, IN (US); Cassidy L. Schumacher, Eureka, IL (US); Aaron C. Luft, Frankfort, IN (US); Justin E. Shreve, Indianapolis, IN (US)

(73) Assignee: Caterpillar Inc., Peoria, IL (US)

(21) Appl. No.: 18/804,780

(22) Filed: Aug. 14, 2024

(51) Int. Cl. F16J 15/08; F02F 1/00

(52) U.S. Cl. CPC F16J 15/0825; F02F 1/004

(57) ABSTRACT

The present application includes a cylinder head gasket for an internal combustion engine that includes a plurality of metal layers that together form a flange portion extending radially to or adjacent a cylinder bore, wherein the plurality of metal layers are configured to be interposed between substantially an entirety of an interface between a cylinder head and a cylinder liner of the internal combustion engine.

### TECHNICAL FIELD

The present disclosure relates to an internal combustion engine. More particularly, the present disclosure relates to a cylinder head gasket and cylinder liner of the internal combustion engine.

### BACKGROUND

Machinery, for example, agricultural, industrial, construction or other heavy machinery can be propelled by an internal combustion engine(s). Internal combustion engines can be used for other purposes such as for power generation. Internal combustion engines combust a mixture of air and fuel(s) in cylinders and thereby produce drive torque and power. Internal combustion engines may be designed to run on gasoline fuel, in which a spark plug initiates combustion, on diesel fuel, that is compression ignited, or on other fuels, such as gaseous fuels. Gaseous fuels are fuels that are in a gaseous state under ordinary conditions such as at standard temperature and pressure.

Internal combustion engines utilize gaskets to form seals between various components including the cylinder head and various components of the engine including the engine block. United States Patent Application No. 2016/0032862A1, European Patent Application No. 3043054A1 and Korean Patent No. 7 KR1 100217470B1 disclose use of gaskets for sealing between the cylinder head and other parts of an internal combustion engine. However, these patent applications and patent do not recognize a cylinder head gasket and cylinder liner with the construction and other benefits in the manner disclosed herein.

### SUMMARY

In an example according to this disclosure, a cylinder head gasket for an internal combustion engine that includes a plurality of metal layers that together form a flange portion extending radially to or adjacent a cylinder bore, wherein the plurality of metal layers are configured to be interposed between substantially an entirety of an interface between a cylinder head and a cylinder liner of the internal combustion engine.

In another example according to this disclosure, an internal combustion engine that includes: a cylinder head; an engine block; a cylinder liner received at least partially within the engine block, wherein the cylinder liner defines a cylinder bore configured to receive a piston therein, and wherein the cylinder liner has an outer surface facing the cylinder head that is substantially flat; and a cylinder head gasket arranged between substantially an entirety of the outer surface of the cylinder liner and the cylinder head, wherein the cylinder head gasket extends to or adjacent the cylinder bore.

In yet another example according to this disclosure, a method of sealing a cylinder bore of an internal combustion engine, the method including: providing a cylinder head and a cylinder liner that defines the cylinder bore; interposing a cylinder head gasket at a joint between the cylinder liner and the cylinder head, the cylinder head gasket positioned between substantially an entirety of the joint and extending to or adjacent the cylinder bore; and compressing the cylinder head gasket.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of an exemplary internal combustion engine in accordance with an example of the present application.

FIG. 2A is an enlarged perspective view of a plurality of cylinder heads mounted to an engine block of the internal combustion engine in accordance with an example of the present application.

FIG. 2B is a perspective view of the internal combustion engine of FIG. 2A with the plurality of cylinder heads removed to show a plurality of cylinder head gaskets, cylinder liners and spacer plates in accordance with an example of the present application.

FIG. 3 is a cross-sectional view a portion of the internal combustion engine including the cylinder head, the cylinder head gasket, the spacer plate and part of the cylinder liner in accordance with an example of the present application.

FIG. 3A is an enlarged schematic view from cross-sectional view of FIG. 3 in accordance with an example of the present application.

FIG. 4 is a perspective view of the cylinder head gasket in accordance with an example of the present application.

### DETAILED DESCRIPTION

Examples of the present disclosure are now described with reference to the accompanying drawings. The following description is merely exemplary in nature and is not intended to limit the present disclosure, application, or use. Examples described set forth specific components, devices, and methods, to provide an understanding of embodiments of the present disclosure. It will be apparent to those skilled in the art that specific details need not be employed and that examples may be embodied in many different forms. Thus, the examples provided should not be construed to limit the scope of the claims.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

Further, relative terms, such as, for example, “about,” “substantially,” “generally,” and “approximately” are used to indicate a possible variation of ±10% in a stated value. As used herein, a “gaseous fuel” may include gaseous fuel such as, natural gas, methane, butane, propane, bio-gas, landfill gas, hydrogen, and blends thereof, for example. Natural gas is an exemplary gaseous fuel having various levels of purity. As used herein “natural gas” refers to both pure and relatively impure forms having various amounts of methane and other constituents. The gaseous fuel may be provided to an intake component of the internal combustion engine in a compressed form. The gaseous fuel may be stored in a liquid form in a storage tank, and converted to gas (e.g. by heating) prior to introduction to the intake component. As used herein, a “liquid fuel” does not include gaseous fuel and may include gasoline, diesel, methanol, ethanol, or any other liquid fuel.

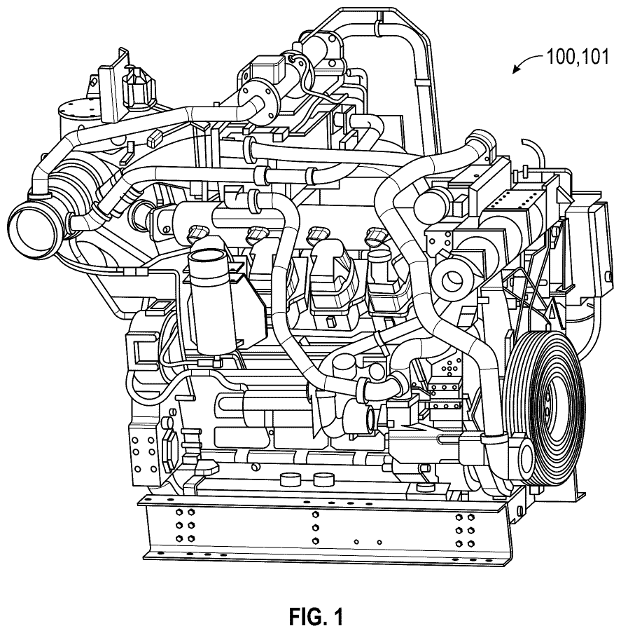

FIG. 1 depicts parts of an internal combustion engine 100 (sometimes referred to as simply as “engine” herein) in accordance with this disclosure. The engine 100 can be used for power generation such as for the propulsion of vehicles or other machinery or for stationary power generation. While the internal combustion engine 100 is depicted as a gas engine 101, embodiments are not limited to gas engines, and embodiments can be implemented on, for example, diesel engines. The gas engine 101 may be any engine configured to generate power using a gaseous fuel, for example, such as an internal combustion engine. Gaseous fuels are fuels that are in a gaseous state under ordinary conditions such as at standard temperature and pressure. The internal combustion engine 100 can include various power generation platforms, and can use various a single fuel of dual fuels including, for example, liquid fuel and/or gaseous fuel. Stationary engines may be used to drive immobile equipment, such as pumps, generators, mills, or factory equipment. It is understood that the present disclosure can apply to any number of piston-cylinder arrangements and a variety of engine configurations including, but not limited to, V-engines, inline engines, and horizontally opposed engines, as well as overhead cam and cam-in-block configurations. Vehicles and working machinery that can be driven include those related to various industries, including, as examples, construction, agriculture, forestry, transportation, material handling, waste management, etc.

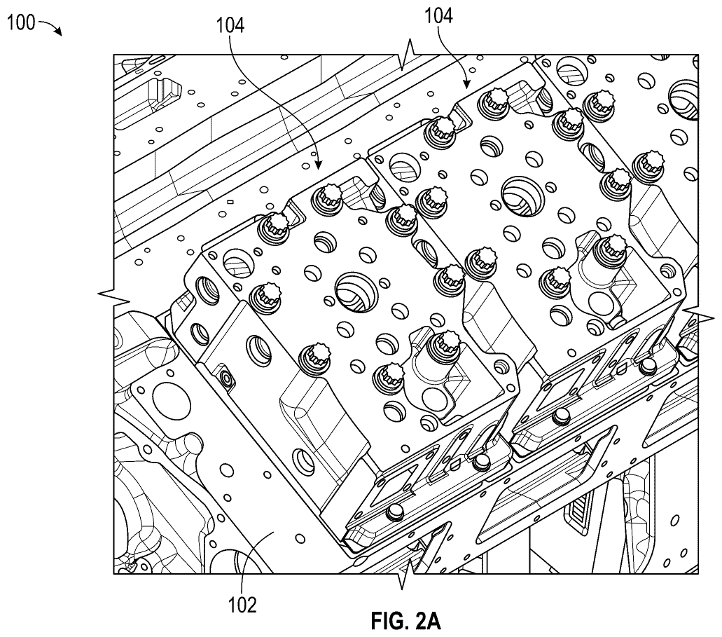

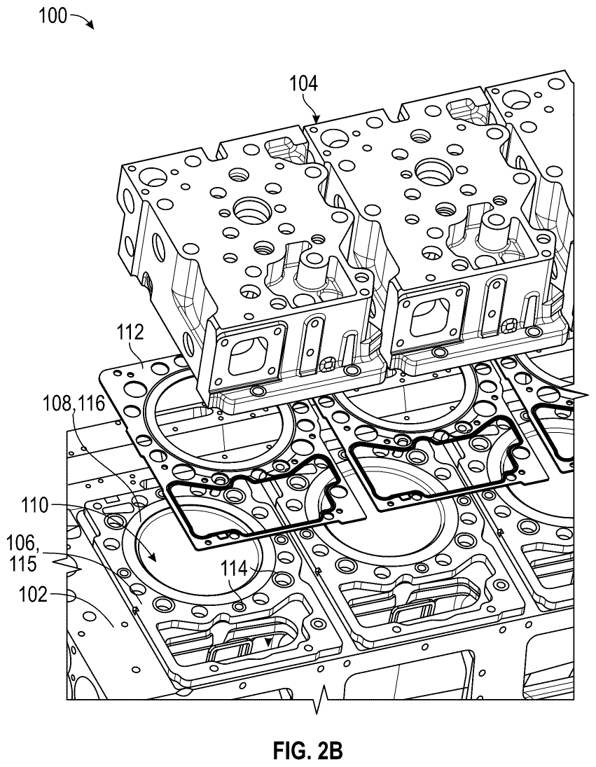

FIG. 2A shows portions of engine 100 that include an engine block 102 and a cylinder head 104. The cylinder head 104 can be mounted to the engine block 102 such as via a spacer plate 106 as shown in the exploded view of FIG. 2B. The engine block 102 receives the cylinder liners (shown in FIG. 2B and discussed subsequently). The cylinder liners may be arranged in any configuration such as inline, radial, “V”, or the like as discussed above. The cylinder liners can define bores that form parts of combustion chambers in which pistons reciprocate. Energy generated from combustion of the fuel inside the cylinder bores can be converted to rotational energy of the crankshaft by the pistons.

The cylinder head 104 and/or a rocker box (not shown) can form a housing for components such as a fuel injector (not shown). Each fuel injector can be in fluid communication with a respective combustion chamber and can be mounted in the cylinder head 104 and/or rocker box. The cylinder head 104 may house one or more components and/or systems (not shown) of the engine 100 such as a valve train, an intake manifold, an exhaust manifold, sensors, etc. Additionally, the engine 100 may include various other components and/or systems (not shown) such as a crankcase, a fuel system, an air system, a cooling system, a turbocharger, an exhaust gas recirculation system, an exhaust gas aftertreatment system, etc.

The engine 100 may also include a fuel rail system. This system can be double walled for enclosure in some cases. The fuel rail system can be fluidly connected to one or more fuel pumps (not shown). The fuel rail system can be configured to receive pressurized gaseous or liquid fuel therein from the one or more fuel pumps. The fuel rail system can be fluidly connected to fuel injectors (not shown) associated with the cylinders of the engine 100. Accordingly, the fuel rail system is configured to supply the pressurized gaseous fuel and/or liquid fuel to each of the fuel injectors.

FIG. 2B shows an exploded view with the cylinder head 104 removed from the spacer plate 106 and the engine block 102. FIG. 2B additionally shows a cylinder liner 108 that forms a cylinder bore 110, a cylinder head gasket 112 and a water ferrule 114 formed by the engine block 102 of the internal combustion engine 100.

As shown in FIG. 2B, the cylinder head gasket 112 is configured to be interposed between the cylinder liner 108 and parts, all or substantially all of the spacer plate 106 and the cylinder head 104. The cylinder head gasket 112 can extend to adjacent (within less than 10 mm, less than 5 mm, less than 2.5 mm, less than 1 mm or the like) of the cylinder bore 110. The cylinder head gasket 112 can additionally extend between parts, all or substantially all of the cylinder liner 108 and the cylinder head 104. According to the example shown in FIG. 2B, the cylinder head gasket 112 can be configured to extend over substantially an entirety of the spacer plate 106. As shown in FIG. 2B, the cylinder head gasket 112 can be shaped along an outer edge to generally correspond to a shape of an outer edge the spacer plate 106. Additionally, the cylinder head gasket 112 can be configured to accommodate the water ferrule 114 by extending around the water ferrule 114 along the spacer plate 106. The water ferrule 114 can be a recess configured to communicate water up into the cylinder head 104.

As shown in FIG. 2B, the engine 100 includes multiple cylinder heads 104, multiple cylinder liners 108 and multiple cylinder head gaskets 112. This arrangement facilitates individual service of the cylinder head 104, cylinder liner 108 and cylinder head gasket 112 should it be desired.

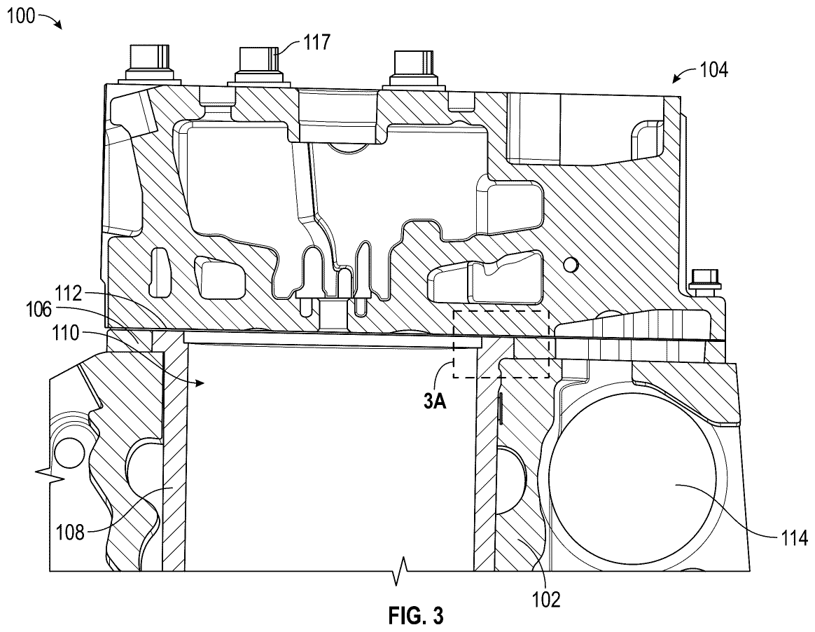

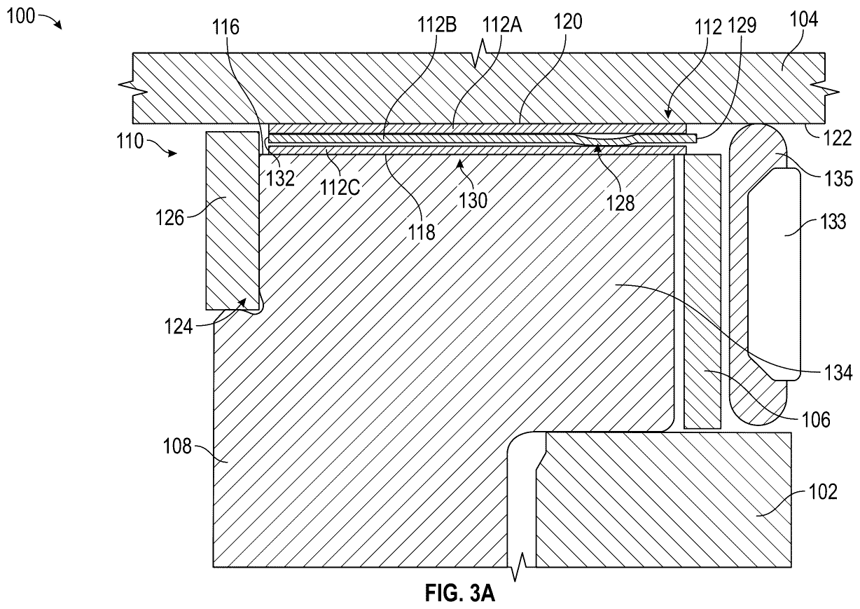

Spacer plate 106 can be proud of the engine block 102. The spacer plate 106 can be a dedicated component separate from and attached to the engine block 102. Alternatively, the spacer plate 106 can be part of the engine block 102 specifically configured for mounting, for example. The spacer plate 106 can be configured to couple with the cylinder head 104 via threaded bores or other features that receive fasteners (fasteners shown in FIGS. 2A and 3) as known in the art. Thus, the spacer plate 106 has a shape the facilitates mounting of the cylinder head 104 thereto. The spacer plate 106 can surround or partially surround the cylinder liner 108. The spacer plate 106 (and/or the engine block 102) can be configured to receive the cylinder liner 108 therein or thereon. As shown in FIG. 2B, an outer surface 115 of the spacer plate 106 can be substantially flush with an outer surface 116 of the cylinder liner 108. The cylinder bore 110 of the cylinder liner 108 is an aperture in which a piston (not shown) can reciprocate. The spacer plate 106 can include a plenum or other opening configured to accommodate part of the water ferrule 114, which extends between the engine block 102 and the cylinder head 104.

FIG. 3 is a cross-sectional view of one of the cylinder heads 104 and portions of the engine block 102, spacer plate 106, cylinder liner 108 and water ferrule 114. FIG. 3 additionally shows the cylinder bore 110 and cylinder head gasket 112. As shown in FIG. 3, the cylinder head gasket 112 is interposed substantially entirely between the cylinder liner 108 and the cylinder head 104 and between parts of the spacer plate 106 and the cylinder head 104. FIG. 3 shows fasteners 117 that couple the cylinder head 104 to the engine block 102 and compress the cylinder head gasket 112.

FIG. 3A is an enlarged schematic view of the cross-section of FIG. 3. FIG. 3 illustrates parts of the cylinder head 104, the spacer plate 106, cylinder liner 108, the cylinder bore 110, the cylinder head gasket 112 as previous discussed an illustrated. As FIG. 3A is schematically drawn, gaps shown in FIG. 3A are highly exaggerated and the shape of some components and gaps are not drawn to scale.

The cylinder head gasket 112 is sandwiched between abutted and pinched (compressed) by the cylinder head 104 and the cylinder liner 108 via the force of fasteners or other components the couple the cylinder head 104 to the internal combustion engine 100. The cylinder head gasket 112 can be relatively more crushable/conformable as compared with the spacer plate 106 or engine block 102. This conformability of the cylinder head gasket 112 allows the cylinder head gasket 112 to conform with outer surfaces of both the cylinder liner 108 and the cylinder head 104 in a manner that creates as seal against methane or other gaseous fuel passing away from cylinder bore 110.

FIG. 3A additionally shows the construction and positioning of the cylinder head gasket 112 and the cylinder liner 108. As shown in FIG. 3A, the outer surface 116 comprising a top surface of the cylinder liner 108. The outer surface 116 can be substantially flat. Thus, the cylinder liner 108 does not include any features (e.g., projections, grooves, etc.) at or along the outer surface 116 that faces the cylinder head gasket 112. Similarly, the cylinder head gasket 112 can be substantially flat or otherwise conforming in shape along one or both of a bottom surface 118 and a top surface 120 thereof. As shown, the cylinder head 104 can be substantially flat along a bottom surface 122 thereof. The bottom surface 122 can abut the top surface 120. The bottom surface 118 can abut the outer surface 116.

FIG. 3A shows the cylinder head gasket 112 can extend to or adjacent (only slightly spaced within less than 10 mm, less than 5 mm, less than 2.5 mm, less than 1 mm) the cylinder bore 110 as previously discussed. According to some examples, an inner edge of the cylinder head gasket 112 can be flush or substantially flush (only slightly spaced within less than 10 mm, less than 5 mm, less than 2.5 mm, less than 1 mm) with the cylinder bore 110.

FIG. 3A shows an example where the cylinder bore 110 includes a groove 124 configured to receive a cuff ring 126 therein. The cuff ring 126 interfaces with the piston (not shown) during a top of the stroke of the piston. The cuff ring 126 is configured to clean the piston as known in the art. Thus, according to some examples the cylinder head gasket 112 can extend to or adjacent (within less than 10 mm, less than 5 mm, less than 2.5 mm, less than 1 mm) the cuff ring 126.

The cylinder head gasket 112 can be a multi-layer steel (MLS) gasket (e.g., stainless or spring steel) although embodiments are not limited to steel and can include any metal or other type of steel, nickel, etc. The cylinder head gasket 112 portion can include an upper metal layer 112A, a middle metal layer 112B and a lower metal layer 112C. The upper metal layer 112A can form the top surface 120. The lower metal layer 112C can form the bottom surface 118. While three layers are depicted, this is for purposes of clarity only. The MLS gasket can include several thinner layers or layers of variable thickness. The plurality of metal layers 112A, 122B and 112C (and indeed the cylinder head gasket 112) can be configured to substantially eliminate any direct abutment between the cylinder liner 108 and the cylinder head 104. This is due to the plurality of metal layers 112A, 112B and 112C (and indeed the cylinder head gasket 112) being configured to be interposed between substantially an entirety of an interface/joint between the cylinder head 104 and the cylinder liner 108.

The upper metal layer 112A can be spot welded, embossed, molded or otherwise affixed to the middle layer 112B at various locations. Similarly, the lower metal layer 112C can be spot welded, embossed, molded or otherwise affixed to the middle metal layer 112B at various locations. As shown in FIG. 3A, the middle layer 112B can be shaped with a convex projection or bump 128 adjacent an outer end 129 thereof. The bump 128 can project toward the lower metal layer 112C. However, the orientation of the bump 128 can be reversed in other embodiments. This bump 128 can form a continuous ridge extending circumferentially around and above the cylinder liner 108 between the lower metal layer 112C and the top metal layer 112A. The bump 128 forms an additional sealing feature within the cylinder head gasket 112. The upper metal layer 112A, the middle metal layer 112B and the lower metal layer 112C can be compressed into sealing engagement (e.g., by a compaction force, by a bolt force, etc.) by a compression force applied on the cylinder head gasket 112.

The bump 128 can be positioned at or spaced from an outer radial edge of the cylinder liner 108. However, the bump 128 can be positioned in another location such as more closely adjacent the cylinder bore 110 or above the spacer plate 106 according to other examples. As a result of the bump 128, the cylinder head gasket 112 has a flange portion 130 that extends radially inward from the bump 128 to an inner end 132 adjacent or at the cylinder bore 110. At the flange portion 130, the upper metal layer 112A, the middle layer 112B and the lower metal layer 112C can extend substantially parallel with one another. The upper metal layer 112A, the middle layer 112B and the lower metal layer 112C can all terminate together thereby forming the inner end 132 radially inward of the bump 128.

According to other embodiments, the cylinder head gasket 112 can include the upper metal layer 112A, the middle layer 112B and the lower metal layer 112C but without the bump 128 as a feature of any of the upper metal layer 112A, the middle layer 112B or the lower metal layer 112C. Rather, a component such as a metal ring can be welded or otherwise connected to the middle layer 112B such as at an outer edge (e.g., a furthest away portion of the cylinder head gasket 112 from the cylinder) thereof. The metal ring can form a continuous ridge extending circumferentially around and above the cylinder liner 108 between the lower metal layer 112C and the top metal layer 112A (and in some cases being proud of at least one of the lower metal layer 112C and the top metal layer 112A.

As shown in FIG. 3A, the cylinder liner 108 can include a flange 134 projecting radially outward over portions of the engine block 102. The flange 134 can form part of the outer surface 116. The spacer plate 106 can be arranged around the cylinder liner 108 radially outward thereof with respect to the cylinder bore 110. The cylinder liner 108 can be positioned adjacent and inward of a metal band 133 and a rubber (or other softer material) over mold 135.

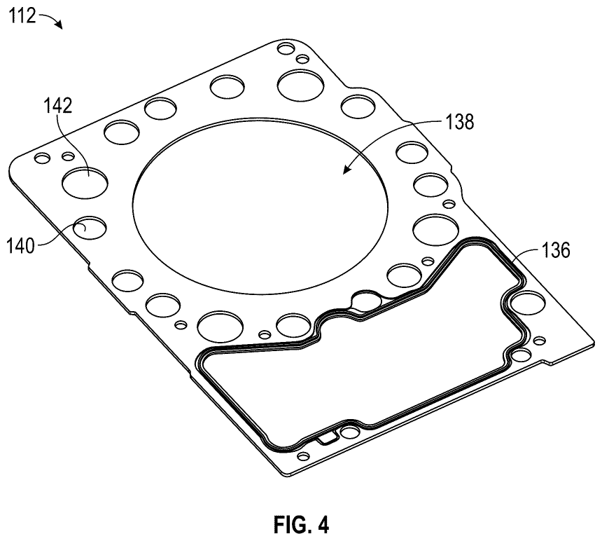

FIG. 4 is a perspective view of the cylinder head gasket 112 additionally showing the shim gasket 136. The water ferrule 114 can be separated from the cylinder head gasket 112 by a shim gasket 136 or another sealing feature as shown in FIG. 4. Shim gasket 136 can form a seal between the cylinder head 104 and the spacer plate 106 for sealing oil, for example. The cylinder head gasket 112 can include a central aperture 138, a plurality of apertures 140 and a water ferrule aperture 142.

The cylinder head gasket 112 can have generally rectangular shape, generally corresponding to the shape of the spacer plate 106 (FIG. 2B). The shim gasket 136 can be positioned generally between the water ferrule aperture 142 and a remainder of the cylinder head gasket 112. The plurality of apertures 140 can be arranged in a pattern around various portions of the cylinder head gasket 112 including adjacent the various edges thereof. The plurality of apertures 140 are configured to receive fasteners (not shown but shown in FIGS. 2A and 3) that couple the cylinder head (not shown) to the internal combustion engine. The central aperture 138 can correspond generally with the cylinder bore 110 (FIG. 2B). The plurality of apertures 140 can be spaced from and patterned around the central aperture 138. Thus, the cylinder head gasket 112 includes the water ferrule aperture 142 therethrough configured to accommodate a water ferrule of the internal combustion engine, the plurality of apertures 140 configured to receive bolts that affix the cylinder head to the internal combustion engine, and the central aperture 138 configured to accommodate the cylinder bore.

### INDUSTRIAL APPLICABILITY

Gaseous fuels have several advantages including cleaner emissions (fewer nitrogen oxides (NOx) and particulate matter compared to conventional fuels like gasoline or diesel), a higher octane number and lower operating costs. However, gaseous fuels pose challenges related to storage, safety and energy density. Additionally, gaseous fuels must be combusted at higher temperatures as compared with diesel and gasoline fuel.

The present application recognizes that the cylinder head gasket 112 can be extended all the way to adjacent the cylinder bore 110 of the cylinder liner 108 such the cylinder head gasket 112 is interposed in a greater area between the cylinder head 104 and cylinder liner 108. This enlarged cylinder head gasket 112 allows the cylinder liner 108 to have a much flatter shape along the outer surface 116 thereof. Previously, it had been thought, particularly with use of gaseous fuels that combust at higher temperatures, that a fire dam or a particularly designed robust and separate seal was required to be used in this area adjacent the cylinder bore. However, the present application recognizes that use of the fire dam or use of the dedicated seal in this area can create a larger than desired crevice volume and this crevice volume can lead to a chance for gaseous fuel to be trapped in between the cylinder head to engine block joint. This trapped gaseous fuel may not fully ignite and is then expelled with the exhaust. This phenomenon can negatively affect engine performance and emissions. Thus, the design of the cylinder head gasket 112 and cylinder liner 108 of the present application are configured to form a better more efficient seal and reduced the risk of unburned fuel escaping.

The present application discloses a modified shape for the cylinder liner 108 and a new shape and size for cylinder head gasket 112. As a result, the cylinder head gasket 112 covers and fills substantially more of the crevice volume than would have otherwise been the case in prior designs. Put another way, the crevice volume (an area with no gasket but just space between the liner and the cylinder head) can be substantially reduced by up to 64% in the present internal combustion engine 100. Thus, the cylinder liner 108 and cylinder head gasket 112 are configured to reduce the crevice volume. This reduction can include by eliminating the fire dam of the cylinder liner that had previously used. Additionally, the cylinder head gasket 112 is provided with a relatively larger size and covers more area including the substantially all or all the area between the cylinder head 104 and cylinder liner 108 that had previously not been covered by the cylinder head gasket in prior designs. For example, the cylinder head gasket 112 can extend to or substantially adjacent the cylinder bore 110. As a result, of the larger cylinder head gasket 112 size and lack of features (e.g., projections, grooves, etc.) along the outer surface 116 of the cylinder liner 108, a more robust and efficient seal can be formed.

The above detailed description is intended to be illustrative, and not restrictive. The scope of the disclosure should, therefore, be determined with references to the appended claims, along with the full scope of equivalents to which such claims are entitled.

1. A cylinder head gasket for an internal combustion engine, comprising:
a plurality of at least three metal layers that together form a flange portion that extends radially inward toward a cylinder bore from a bump between an internal layer of one of the plurality of at least three metal lavers and an adjacent laver wherein the plurality of at least three metal layers are configured to be interposed between substantially an entirety of an interface between a cylinder head and a cylinder liner of the internal combustion engine, wherein each of the plurality of at least three metal layers of the flange portion terminate to form an inner radial edge at or adjacent the cylinder bore, wherein the flange portion is positioned over a body of the cylinder liner and the bump is positioned over a flange of the cylinder liner a radial distance from the cylinder bore.

2. (canceled)

3. The cylinder head gasket of claim 1, wherein the plurality of at least three metal layers are configured to substantially eliminate any direct abutment between the cylinder liner and the cylinder head.

4. The cylinder head gasket of claim 1, wherein the plurality of at least three metal layers are configured to extend over substantially an entirety of a spacer plate that surrounds at least a portion of the cylinder liner, and wherein the plurality of at least three metal layers are shaped along an outer edge to generally correspond to a shape of an outer edge the spacer plate of the internal combustion engine.

5. The cylinder head gasket of claim 1, wherein the plurality of at least three metal layers extend generally parallel with one another in the flange portion.

6. The cylinder head gasket of claim 1, wherein the cylinder head gasket includes a first aperture therethrough configured to accommodate a water ferrule of the internal combustion engine, a second plurality of apertures configured to receive bolts that affix the cylinder head to the internal combustion engine, and a central aperture configured to accommodate the cylinder bore.

7. The cylinder head gasket of claim 1, wherein each of the plurality of at least three metal layers is spot welded to an adjacent of the plurality of at least three metal layers.

8. An internal combustion engine comprising:
a cylinder head;
an engine block;
a cylinder liner received at least partially within the engine block, wherein the cylinder liner defines a cylinder bore configured to receive a piston therein, and wherein the cylinder liner has an outer surface facing the cylinder head that is substantially flat; and
a cylinder head gasket arranged between substantially an entirety of the outer surface of the cylinder liner and the cylinder head, wherein the cylinder head gasket extends to or adjacent the cylinder bore, wherein the cylinder head gasket includes at least three metal layers that together form a flange portion that extends radially inward toward the cylinder bore from a bump between an internal layer of one of the at least three metal lavers and an adjacent laver, wherein each of the at least three metal layers of the flange portion terminate to form an inner radial edge at or adjacent the cylinder bore, wherein the flange portion is positioned over a body of the cylinder liner and the bump is positioned over a flange of the cylinder liner a radial distance from the cylinder bore, wherein the internal combustion engine is a gas engine configured to combust a gaseous fuel.

9. (canceled)

10. (canceled)

11. (canceled)

12. The internal combustion engine of claim 8, wherein the at least three metal layers extend generally parallel with one another in the flange portion.

13. The internal combustion engine of claim 8, further comprising a spacer plate that surrounds the cylinder liner and is coupled to or formed by part of the engine block, wherein the cylinder head gasket extends over substantially an entirety of a spacer plate.

14. The internal combustion engine of claim 13, wherein the cylinder head gasket is shaped along an outer edge to generally correspond to a shape of an outer edge the spacer plate of the internal combustion engine.

15. The internal combustion engine of claim 13, wherein the outer surface of the cylinder liner is substantially flush with an outer surface of the spacer plate.

16. The internal combustion engine of claim 8, wherein the cylinder head gasket includes a first aperture therethrough configured to accommodate a water ferrule of the internal combustion engine, a second plurality of apertures configured to receive bolts that affix the cylinder head to the internal combustion engine, and a central aperture configured to accommodate the cylinder bore.

17. The internal combustion engine of claim 8, wherein the internal combustion engine includes a plurality cylinder heads including the cylinder head and a plurality of cylinder head gaskets including the cylinder head gasket.

18. A method of sealing a cylinder bore of an internal combustion engine, comprising:
providing a cylinder head and a cylinder liner that defines the cylinder bore;
interposing a cylinder head gasket at a joint between the cylinder liner and the cylinder head, the cylinder head gasket positioned between substantially an entirety of the joint and extending to or adjacent the cylinder bore, wherein the cylinder head gasket includes at least three metal layers that together form a flange portion that extends radially inward toward the cylinder bore from a bump between an internal layer of one of the at least three metal lavers and an adjacent laver, wherein each of the at least three metal layers of the flange portion terminate to form an inner radial edge at or adjacent the cylinder bore, wherein the flange portion is positioned over a body of the cylinder liner and the bump is positioned over a flange of the cylinder liner a radial distance from the cylinder bore; and
compressing the cylinder head gasket to form a seal against products of combustion from a gaseous fuel.

19. The method of claim 18, further comprising positioning the cylinder head gasket to cover substantially all of a spacer plate that surrounds the cylinder liner and separates the cylinder liner from the cylinder head.

20. The method of claim 18, wherein the cylinder liner has an outer surface facing the cylinder head that is substantially flat.
